(19) United States
(12) Patent Application Publication
(10) Pub. No.: US 2025/0213427 A1
(43) Pub. Date: Jul. 3, 2025

(54) VERSATILE SYSTEM FOR LOCALIZED ACUPOINT MICRODOSING

(71) Applicant: Samuel M Lam, Plano, TX (US)

(72) Inventor: Samuel M Lam, Plano, TX (US)

(21) Appl. No.: 18/400,505

(22) Filed: Dec. 29, 2023

(51) Int. Cl. A61H 39/02; A61H 39/08

(52) U.S. Cl. CPC A61H 39/02; A61H 39/086

(57) ABSTRACT

The present disclosure details a versatile treatment modality—comprising numerous combinations, formulations, constructs, and methods—for remediating or alleviating a wide variety of acute and chronic medical illnesses and infirmities. The present invention comprehends and discloses novel remediation modalities that are not currently used. The present invention provides a mapping basis corresponding to a medical condition to be treated, and a target area for treatment defined relative to the mapping basis. A treatment point is identified within the target area, and a treatment dose of medically approved toxin is injected into the treatment point.

### TECHNICAL FIELD OF THE INVENTION

The present disclosure relates generally to the field of treating various acute and chronic medical conditions with modalities utilizing aspects of acupuncture and medically safe injectable toxins, and—more particularly—to systems, combinations, formulations, constructs, and methods for providing localized acupoint microdosing in the treatment of a variety of medical illnesses, infirmities, and conditions.

### BACKGROUND OF THE INVENTION

Acupuncture is an ancient Chinese medical practice dating back thousands of years. More recently, however, it has transcended its cultural origins to become a widely recognized and increasingly accepted form of therapy in Western medicine.

The origins of acupuncture can be traced to ancient China, where it emerged as a key component of Traditional Chinese Medicine (“TCM”). The earliest known documentation on acupuncture dates to the second century B.C. According to TCM principles, the body's vital energy, known as Qi, flows along pathways called meridians. When this flow is disrupted or blocked, it is believed to lead to illness. Acupuncture aims to restore balance and harmony by inserting thin needles into specific points along these meridians.

Throughout history, acupuncture evolved and diversified, with a range of styles and techniques emerging. The practice spread across Asia and eventually reached the West. The integration of acupuncture into Western medicine gained momentum in the latter half of the 20th century, and the National Institutes of Health (NIH) in the United States released a consensus statement in 1997 supporting the use of acupuncture for certain conditions. Acupuncture is now utilized in Western medicine for a range of conditions, both as a standalone therapy and as a complementary approach.

Acupuncture has gained widespread acceptance in managing chronic pain conditions, such as osteoarthritis, migraines, and lower back pain. Acupuncture is employed in alleviating nausea and vomiting associated with chemotherapy, pregnancy (morning sickness), and postoperative recovery. Mental health care has increasingly integrated acupuncture. It has shown promise in reducing symptoms of anxiety, depression, and post-traumatic stress disorder (PTSD). Other applications of acupuncture include musculoskeletal issues, such as sports injuries, fibromyalgia, rheumatoid arthritis, and fertility and reproductive health.

Often, individuals seek acupuncture for chronic conditions that have developed over an extended period. Conditions such as chronic pain, arthritis, or digestive disorders often involve complex underlying factors that necessitate a comprehensive approach. Conventional acupuncture aims to address these complexities by influencing various physiological processes, and achieving substantial and lasting improvements may take time.

Acupuncture is thought to modulate the nervous system, influencing pain perception, inflammation, and overall homeostasis. The process involves the stimulation of specific acupuncture points, which triggers a cascade of neurochemical responses. These changes in neurological pathways are most often gradual- and contribute to the time required for the body to adapt and generate therapeutic effects. In addition, acupuncture sessions are typically cumulative in their impact. While each session contributes to the overall therapeutic goal, the effects may not be immediately apparent. The body's response to acupuncture is often a gradual and cumulative process, with repeated sessions building upon previous ones to achieve a more pronounced and sustained outcome. Additionally, traditional acupuncture relies on individualized diagnosis and treatment plans, posing numerous challenges for reproducibility or standardization.

Traditional acupuncture typically requires multiple sessions—usually twice weekly over many months—with needles placed at varying depths, angles (oblique vs. perpendicular), and duration, and may utilize other supportive techniques (e.g., moxibustion, dry needling). Acupuncture is not suitable for emergency medical situations or acute conditions that require immediate intervention. Its primary role is in managing chronic conditions or providing complementary support, and it does not provide immediate treatment or relief.

Another recent treatment modality-Botulinum toxin (“BT”)—has also evolved over time. BT was initially avoided in the medical field for a lengthy time but has been more recently investigated as a therapeutic agent in modern medical treatments. Botulinum toxin was first identified in the early 19th century and is characterized by its paralytic effects on the neuromuscular system. This led to its initial classification as a deadly poison. However, in the late 20th and early 21st centuries, researchers began to explore its therapeutic potential in various medical applications. For example, BT has become an acceptable treatment for focal dystonia. By selectively inhibiting the release of acetylcholine at neuromuscular junctions, BT reduces muscle contractions and relieves symptoms. In other instances, such as muscle spasticity resulting from conditions like cerebral palsy or stroke, BT injections are used to target overactive muscles, providing relief, and improving function.

Most recently, one of the most widely recognized applications and uses for BT is in cosmetic dermatology, to temporarily reduce facial wrinkles. By blocking nerve signals to specific facial muscles, it can smooth fine lines and wrinkles. Another recent application and use of BT injection involves prophylactic treatment of chronic migraines. Its exact mechanisms, and precise emplacements in migraine relief are not fully understood, but it is believed that BT can modulate pain signaling pathways.

Current medical usage of BT is not without limitations and potential dangers. Despite efforts to target specific muscles or glands, BT can sometimes spread beyond the intended site, leading to unintended paralysis. This can result in weakness or adverse effects in neighboring muscles or systems, impacting patient safety and treatment outcomes. Furthermore, existing applications of BT are temporary, typically lasting only a few months. This necessitates repeated injections for sustained therapeutic benefits, exposing patients to the risks associated with repeating the procedure multiple times.

Furthermore, current medical applications of BT injections vary widely in dosing and specific placement. In cosmetic dermatology applications, conventional dosing can vary (depending upon formulation) anywhere from 10 units to 50 units—placed vary subjectively based upon trial-and-error experimentation, and the judgment of more experienced injectors. In migraine treatment applications, conventional dosing is typically on the order of 150 units—subjectively injected at a combination of 31 already identified injection sites.

There is therefore a need for a versatile system of combinations, formulations, constructs, and methods that overcomes the limitations and risks associated with existing treatment modalities such as acupuncture and BT injections.

### SUMMARY OF THE INVENTION

The present invention recognizes that there are numerous risks, limitations, and inefficiencies that accompany existing medical treatment modalities such as acupuncture and BT injections. The present disclosure details a versatile treatment modality that provides combinations, formulations, constructs, and methods for remediating or alleviating a wide variety of acute and chronic medical illnesses and infirmities throughout the body (“Conditions”). The present invention comprehends and discloses novel remediation modalities that are not currently used.

In certain embodiments of the present invention, a microdose (e.g., 1/50^{th} of 1 unit, or less) of a medically approved toxin (“MAT”)—such as BT—is injected in one or more localized areas associated with one or more mapping basis(es) (“Mapping Basis” or “Mapping Bases”). Such Mapping Bases may comprise traditional acupuncture points (“TAPs”) or some other preidentified treatment, release, or trigger points.

The present invention recognizes that application precisely at a Mapping Basis may be less effective than application within a localized area or region having a locus around that point. The present invention further recognizes the inefficiencies inherent in existing treatment techniques. Existing techniques typically require repeated treatment-building up a cumulative effect at a single point—to provide any change in, or relief from, an underlying Condition.

In contrast, the treatment modalities of the present invention are applied to an area or region—having a particular cross-sectional characteristic—that is mapped to or otherwise associated with treatment of an underlying Condition using a Mapping Basis (including, but not limited to, TAPs). Rather than focusing on alteration or redirection of energy flow at a single point, the present invention focuses on remediation of neuromuscular, vascular, or other bodily tissue in a defined area surrounding or adjacent to such a point. As a result, the present invention provides more immediate and longer-lasting relief than existing treatment or remediation techniques. In some instances, the present invention may provide permanent remediation of the underlying Condition.

The systems and methods of the present invention provide remediation in a defined area with a microdose application of MAT. The present invention's utilization of MAT is much different than existing applications. One particularly significant difference is that existing applications typically rely upon MAT doses that are several orders of magnitude higher than utilized in the present invention. There is a much higher risk of unintended damage to surrounding neuromuscular, vascular, or other bodily tissue in existing methods. Furthermore, the highly subjective application sites and doses associated with conventional approaches most often lead to temporary results that require ongoing, repetitive retreatment.

The present invention thus provides a novel treatment modality that inventively combines mapping of bodily release or stimulation points with MAT modulation of neurotransmitter release and muscle contraction. The present invention optimizes therapeutic effects of its treatment systems and methods, and thereby provides sustained results. Depending upon the Condition being treated, the present invention may provide for retreatment if desired or necessary. In contrast to conventional modalities, however, such retreatment is less frequent and may, over time, become unnecessary.

Among the numerous embodiments disclosed, the present invention provides a method of treating a Condition that determines a Mapping Basis for the Condition to be treated. A target area for treatment (“Target Area”) is defined relative to the Mapping Basis, and a treatment point (“Treatment Point”) within the target area is identified. A treatment dose of MAT is injected into the Treatment Point.

Other embodiments of the present invention provide a system for localized acupoint microdosing treatment of a medical condition. A Mapping Basis corresponds to a medical condition to be treated, and a Target Area for treatment is defined relative to the Mapping Basis. A Treatment Point, identified within the Target Area, is injected with a treatment dose of MAT.

Still other embodiments of the present invention provide a method of localized acupoint microdosing to treat a medical condition. For the medical condition to be treated, a Mapping Basis is determined, a Target Area for treatment is defined relative to the Mapping Basis, and one or more Treatment Points are identified within the Target Area. A treatment dose of MAT is injected into the Treatment Point(s).

The systems and methods of the present invention may be applied to a wide variety of acute and chronic Conditions throughout the body. Other features and advantages of the present disclosure will be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIGS. 1a-1c illustratively depict aspects of an embodiment of treatment in accordance with the present invention;

FIGS. 2a-2f illustratively depict a variety of Target Areas in accordance with the present invention;

FIGS. 3a-3c illustratively depict aspects of an embodiment of treatment in accordance with the present invention; and

FIGS. 4a-4b 21 illustratively depict a table of Conditions to be remediated and Mapping Bases upon which the Target Area for the present invention's treatment may be based.

### DETAILED DESCRIPTION OF THE DISCLOSURE

While the making and using of various embodiments of the present disclosure are discussed in detail below, it should be appreciated that the present disclosure provides many applicable inventive concepts, which can be embodied in a wide variety of specific contexts. The description hereinafter details numerous illustrative embodiments of the present invention's systems and methods for localized acupoint microdosing (“LAM”) in the treatment of various Conditions. The illustrative embodiments and topologies described herein are, however, merely examples of a variety of ways to make and use the disclosed invention—and they are not presented in an order or manner that should be construed to limit the scope of this disclosure. Quite the opposite is true, in fact. There are numerous variations and embodiments that—with the benefit of this disclosure—are enabled for those of skill in the art.

Numerous operational methods, constructs, elements, and/or components are provided by the present invention to render the LAM treatment modality for various Conditions. Unless otherwise specifically indicated otherwise, these methods, constructs, elements, and/or components may be provided as independent methods, procedures, components, or segments, or as varied combinations of each. Thus, all such methods, constructs, elements, segments and/or components may be applied individually, or in combination. Even where additional or alternative embodiments are described or illustrated, this disclosure comprehends further variations that are not explicitly described or depicted.

The present invention is described in greater detail now with reference to the following description and the drawing figures. It should be clearly understood that the embodiments disclosed herein are provided for illustrative purposes, but in no way are intended to limit the scope of the present invention. Upon reference to the present disclosure, the drawing figures, and the illustrative embodiments therein, those of skill in the art will be enabled to practice not only the embodiments depicted, but also numerous other embodiments of the present invention that are not explicitly illustrated. All such embodiments are, however, comprehended by the present invention and fall within the intended scope of the present disclosure.

The present invention comprises a unique system for application of MAT (e.g., BT) into an area or region-having a particular cross-sectional characteristic—that is mapped to or otherwise associated with treatment of an underlying Condition (referred to herein as Target Area). In certain embodiments, the Mapping Basis is based upon TAPs. In other embodiments, the Mapping Basis is based upon existing treatment or release points for migraine therapy. In still other embodiments, the Mapping Basis may be based upon other existing treatment points, trigger points, or release points specific to a given patient previously identified by a practitioner, in addition to treatment or release points previously unidentified. In other words, the present invention comprehends a wide variety of points-including, but not limited to, TAPs, trigger points, and specific treatment points associated with a given patient-being utilized as the Mapping Basis. These and other variations and combinations are included within the scope of the present invention.

According to the present invention's LAM treatment of various Conditions, the types of Conditions that may be successfully remediated or treated include—but are not limited to—physiological, psychological, emotional, and behavioral medical conditions.

The present invention's LAM treatment provides immediate improvement in such Conditions and may be utilized as a stand-alone treatment regimen or as a complement to other medical interventions.

The present invention recognizes that MAT has previously been thought of only as a blocking agent of the neuromuscular endplate to prevent firing of a muscle by inhibiting release of the neurotransmitter acetylcholine. Other sources have postulated that MAT may have a similar effect on nociceptors. Unlike existing MAT applications, the present invention's LAM treatment modality does not interfere with muscle activity-due to the present invention's microdosing and highly selective placement. In certain embodiments of the invention, the MAT is highly diluted, eliminating present adverse side effects otherwise associated with conventional MAT applications—other than possible temporary bruising and pain during the injection process.

In further contrast to previous approaches, the LAM treatment modality of the present invention provides an instant improvement in symptoms of a Condition. The present invention recognizes that LAM treatment provides an ancillary effect on peripheral nerves, providing improved neural connectivity. Furthermore, the treatment of the present invention does not rely upon the modulation of acetylcholine-eliminating hours or even days of waiting for the effects of such modulation to present.

In certain embodiments, the LAM treatment of the present invention applies highly diluted amounts of MAT, into the immediate subcutaneous plane at an area or region (“Target Area”) associated with the Mapping Basis.

As described above, certain embodiments of the present invention's Mapping Basis utilize TAPs while other embodiments utilize other identified treatment or release points. The present invention's Target Area is identified by tracing out an entire expanse surrounding a Mapping Basis. According to the present invention, this may be done by identifying where a needle elicits neurologic discomfort.

Target Areas may vary in location, size, and shape for a given individual. The LAM treatment modality comprises tracing out the extent of a Target Area by placing small aliquots of MAT into and around a TAP, or other Mapping Basis.

According to the present invention, and unlike existing treatment modalities, factors such as depth of a needle, needle size, angle of needle entry, and duration of needle placement are not critical to effective treatment. LAM application of a MAT is sufficient to treat the Target Area.

In certain embodiments, the Target Area comprises a single small point. In other embodiments, the Target Area is larger than a single point, and has certain shape or cross-sectional characteristics. For example, the Target Area may be circular, oval, asymmetrical in shape, or symmetric with linear extensions horizontally and/or vertically from a Mapping Basis (e.g., a TAP).

The present invention's LAM treatment modality effectively treats a wide variety of neuromuscular, degenerative, behavioral, mental, and cosmetic Conditions including (but not limited to): anxiety, depression, anger, attention deficit hyperactivity disorder (ADHD), chronic fatigue, obsessive compulsive disorder (OCD), smoking cessation, weight loss/cravings, drug addiction, alcoholism, sleep disorders, eczema, hives, sweating, acne, other skin disorders, postoperative pain, neck pain, shoulder pain/frozen shoulder, back pain, sciatica, finger pain, trigger finger, wrist pain/carpal tunnel syndrome, hand/arm pain, hip pain, knee pain, ankle/foot pain, heel pain, plantar fasciitis, gout, TMJ pain, scoliosis, menstrual cramps, trigeminal neuralgia, arthritis/joint pain, pain related to shingles, dementia, Alzheimer's, ALS, brain fog, ocular muscle paralysis, facial paralysis/Bell's palsy, ptosis, Parkinson's, hearing loss, tinnitus, vertigo, loss of (or altered) taste and smell, neuralgias, multiple sclerosis, shingles, menopause symptoms, nausea/vomiting, low testosterone, erectile dysfunction, male and female infertility, abnormal menstruation, hormone balancing, bladder dysfunction, irritable bowel syndrome and other gastrointestinal disorders, bloating, GERD/reflux disease, liver disease, COPD/lung disease, hemorrhoids, hoarseness, autoimmune disorders, dry eye, night vision issues, retinopathy, sinusitis, allergies, toothache, flu, high blood pressure, diabetes, motion sickness, and Raynaud's syndrome. This list of Conditions is for illustrative purposes only and does not limit the entire scope of Conditions to which LAM treatment according to the present invention may be successfully applied.

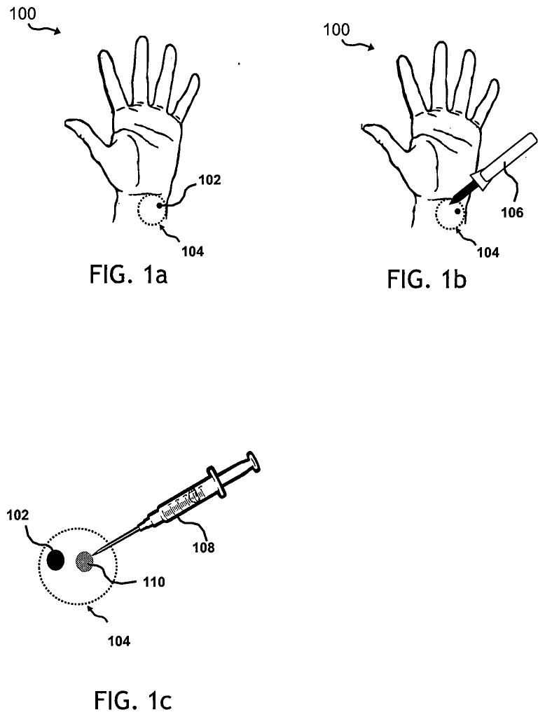

Referring now to FIGS. 1a-1c, an exemplary embodiment of LAM treatment is illustrated. This embodiment illustrates application of LAM treatment for anxiety and/or depression Condition(s). A Mapping Basis is determined or selected based upon the Condition to be treated. In FIG. 1a, a patient's hand and wrist area 100 is depicted. In this embodiment, LAM treatment is based upon Mapping Basis 102—which in this illustrative embodiment is known as TAP HT 7. Based upon Mapping Basis 102, the LAM treatment focuses on Target Area 104.

In FIG. 1b, area 104 is cleaned with an alcohol swab before treatment. A vibration anesthetic device (“VAD”) 106 is applied proximal to area 104 to mitigate discomfort to the patient.

As depicted in FIG. 1c, a 30-gauge needle attached to a 1-ml syringe 108 is used to inject tiny aliquots of BT-diluted to 1 unit per 1-ml syringe-into an identified point (“Treatment Point” or “Acupoint”) within Target Area 104. Alternative embodiments of the present invention may provide a thinner or thicker gauge needle. Similarly, some embodiments of the present invention will provide syringes of lower and higher capacity. All such variations and combinations are comprehended by the present invention.

Depending upon the Condition being treated, and the part of the body where Mapping Basis 102 is located, the tiny aliquot of BT—or any other MAT—consists of 1/50^{th} of 1 unit. This treatment dose (“Treatment Dose”) may vary widely depending upon the factors cited herein. In certain embodiments, the Treatment Dose may consist of as little as 1/100^{th} of 1 unit or less. In other embodiments, the Treatment Dose may consist of 1/10^{th} of 1 unit. The concentrations of MAT, and thus the effective Treatment Dose, may be adjusted by diluting original MAT material—with a medically suitable dilutant, such as saline—by a factor of 10 to 1000 prior to drawing into a syringe. Relative to existing treatment modalities, these Treatment Doses may be referred to or thought of as microdoses, even though they—in some instances, depending upon dilution of the MAT—may or may not technically be 1/1,000,000^{th} of a conventional dose.

In other embodiments of the present invention as disclosed herein, a Treatment Dose may comprise a higher concentration of MAT-such as an amount closer to conventional MAT dosing. As long as such a dose is applied in accordance with the other aspects of this invention, the desired treatment effect(s) may still be realized. These and other variations on the Treatment Dose are all comprehended by the present invention.

In certain instances, a single Treatment Dose injected into the Treatment Point may provide the desired remediation for anxiety and/or depression. The Treatment Point in this embodiment is an acupoint based upon Mapping Basis 102, or it may be another Treatment Point 110 within area 104. In other embodiments, there may be several Treatment Points within a given Target Area. In still other embodiments described hereafter, Treatment Points within a plurality of Target Areas may be combined. Treatment Points within a given Target Area may be predefined, or they may be defined based upon an iterative mapping process. For purposes of this disclosure, acupoint and Treatment Point may be used interchangeably to refer to any Treatment Point, regardless of whether the Treatment Point is an initially identified Mapping Basis (e.g., a TAP) or some other point within a Target Area.

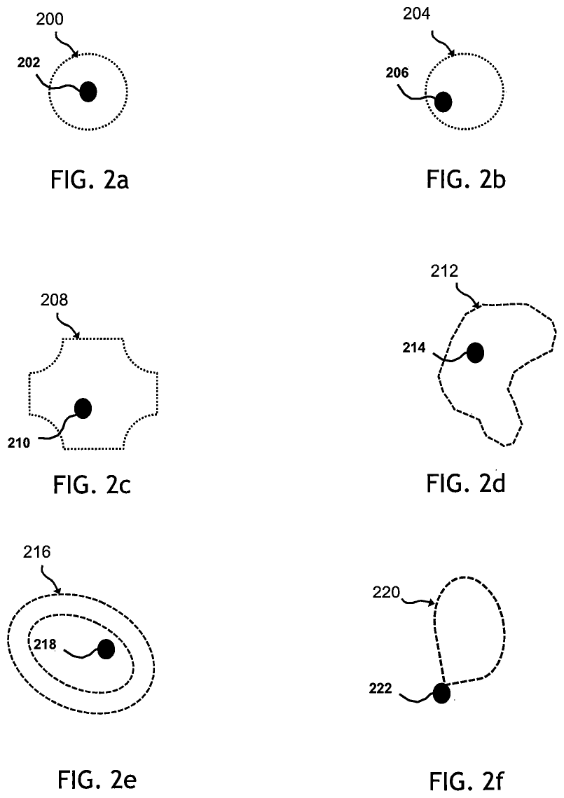

Other aspects of the present invention are illustrated with reference to FIGS. 2a-2f. These figures illustrate various embodiments of defining a Target Area's shape and position relative to a Mapping Basis. In FIG. 2a, Target Area 200 is symmetrically shaped and radially centered on Mapping Basis 202. In FIG. 2b, Target Area 204 is symmetrically shaped, but is not centered Mapping Basis 206. In FIG. 2c, Target Area 208 is a regular shape that may be symmetric (as depicted) or non-symmetric (not depicted) that is not centered on Mapping Basis 210. FIG. 2d depicts an irregularly shaped Target Area 212 that encompasses—but is not centered on-Mapping Basis 214. FIG. 2e depicts Target Area 216 that surrounds, but does not include, Mapping Basis 218. In FIG. 2f, Target Area 220 is irregularly shaped and immediately adjacent to Mapping Basis 222. Target Area may include Mapping Basis 222, or exclude Mapping Basis 222, depending upon the patient or treatment.

The present invention comprehends and includes these and numerous other Target Area shape and position embodiments with respect to a Mapping Basis. In certain embodiments, for example, a Target Area may comprise one or more linear extensions from a Mapping Basis. Numerous factors may affect or influence this shape and position relationship, including—but not limited to—patient anatomy and physiology, condition of the treatment site, and response(s) to previous treatment at that Target Area. In some embodiments, more than one Treatment Point may be included within a given Target Area. The distribution or location of a plurality of Treatment Points with a given Target Area may be provided in various configurations, in a similar fashion to the shape and position relationship. The present invention thus comprehends numerous variations that are not explicitly described or depicted.

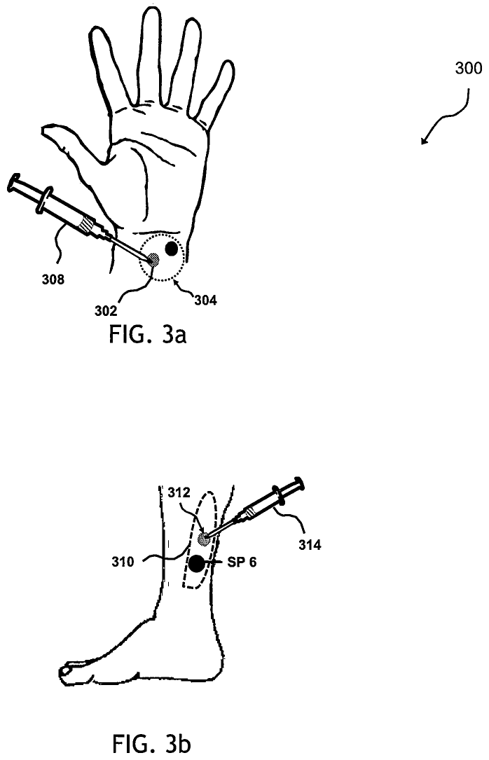

Referring now to FIGS. 3a and 3b, another illustrative embodiment of LAM treatment is depicted. Like the process described in relation to FIGS. 1a-1c, this embodiment illustrates application of LAM treatment 300 for anxiety and/or depression Condition(s). In a first portion of treatment 300 depicted in FIG. 3a, LAM treatment is applied to Treatment Point 302 within Target Area 304, via injection from syringe 308. As in FIGS. 1a-1c, this first portion of treatment 300 is localized to a target area proximal to a Mapping Basis (e.g., TAP HT 7).

In FIG. 3b, a second portion of treatment 300 is localized to a Target Area 310 proximal to a different Mapping Basis (e.g., TAP SP 6). LAM treatment is applied to Treatment Point 312 within Target Area 310, via injection from syringe 314. If necessary or desired, additional Target Areas may be utilized to enhance or complete treatment response.

As disclosed above, different embodiments will utilize different Doses, and may involve treatment applied to more than one Treatment Point within a given Target Area. All such variations are comprehended by the present invention. In addition, embodiments of the present invention may be applied to a variety of Target Areas based upon multiple Mapping Bases across the human body.

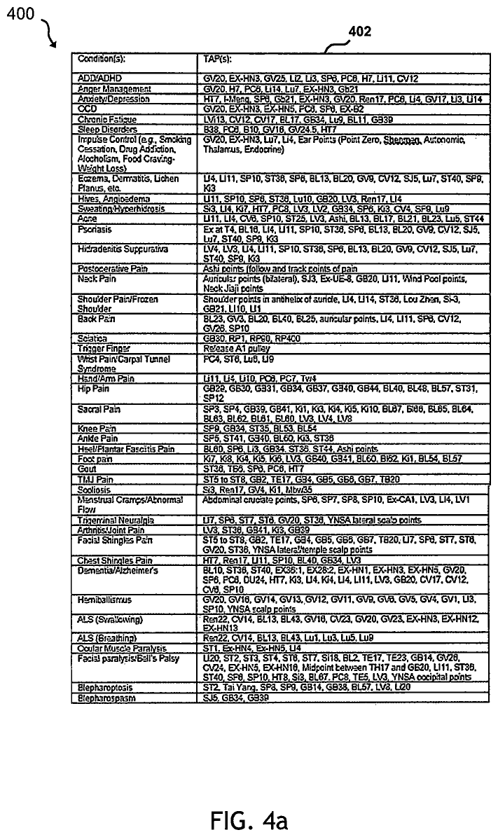

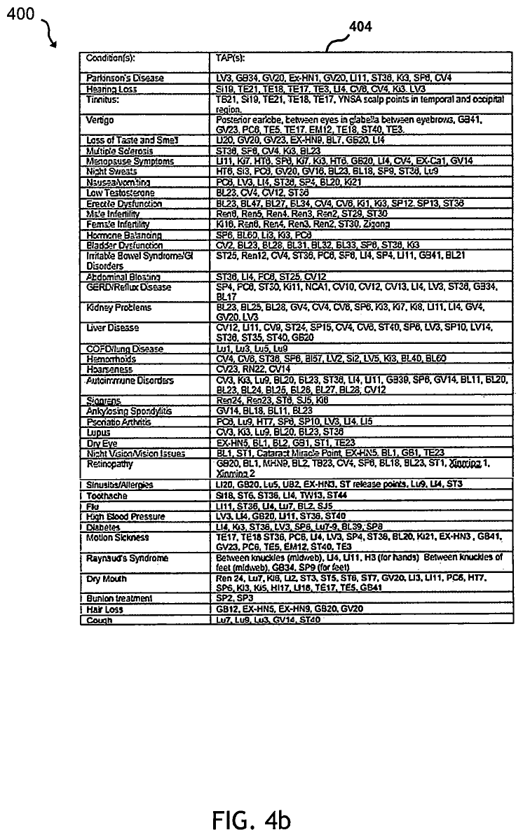

With respect to this teaching of the present invention, reference is now made to Table 400 of FIGS. 4a & 4b. First portion 402 of Table 400 is depicted in FIG. 4a, while second portion 404 of Table 400 is depicted in FIG. 4b. Table 400 comprises two columns. The left column lists one or more Conditions to be remediated using LAM treatment, and the right column lists one or more Mapping Basis(es) upon which the Target Area for LAM treatment may be based. In the embodiment depicted in FIGS. 4a and 4b, the Mapping Basis is a series of TAPs. Other embodiments may provide, as a Mapping Basis, a series of TAPs in combination with other points or areas or, alternatively, a series of points or areas that do not utilize TAPs. These and other combinations and variations are fully comprehended by the present invention.

It should be understood and appreciated that LAM treatment for any given Condition may be based solely on one of the Mapping Bases listed in Table 400. Alternatively, LAM treatment for any given Condition may utilize Target Areas based upon a plurality of the TAPs listed. Any number of variable factors-including, but not limited to, severity of the Condition and responsiveness of patient to treatment—may affect the utilization of multiple Target Areas for any given Condition. The present invention comprehends all such variable factors and includes them within the scope of LAM treatment.

Additional Treatment Points may be treated in instances where a Treatment Area needs to be mapped out more extensively (e.g., a wider area). It should be understood and appreciated that—in instances of treating a plurality of Conditions simultaneously—any given Treatment Point(s) that are listed for more than one Condition need only be treated once. In other words, once a Treatment Point has been treated for one applicable Condition, it may be considered treated for all applicable Conditions.

As described herein, the present invention provides versatile systems, combinations, formulations, constructs, and methods for remediating or alleviating a wide variety of acute and chronic illnesses, infirmities, and conditions throughout the body.

The present invention identifies, comprehends, and solves previously unrecognized and/or unaddressed problems, needs, and risks associated with existing treatment modalities. The present invention's novel treatments system inventively combines mapping of bodily stimulation points with MAT modulation of neurotransmitter release and muscle contraction. The present invention optimizes therapeutic effects of its treatment, and thereby provides sustained results previously unattained.

As already described herein, there are numerous variations in the constructs, configurations, formulations, and applications of the elements of the present invention. Although a wide variety of embodiments, elements, and methods have been described above in connection with the present disclosure, those of skill in the art will appreciate that the above-described embodiments are merely examples of numerous embodiments of the present invention.

All embodiments described herein are presented for purposes of illustration and explanation only. The specific compositions, configurations, methods, arrangements and operations of various features and elements may be provided in numerous ways in accordance with the present disclosure, and fully comprehended thereby.

Therefore, the embodiments and examples set forth herein are presented to best explain the present disclosure and its practical application, and to thereby enable those skilled in the art to make and utilize the disclosure. As previously explained, those skilled in the art will recognize that the foregoing description and examples have been presented for the purpose of illustration and example only. The description as set forth is not intended to be exhaustive or to limit the disclosure to the precise form disclosed. Many modifications and variations are possible considering the above teaching without departing from the spirit, scope, or enablement of the present disclosure.

What is claimed is:

1. A method of treating a medical condition, comprising the steps of:
determining, for the medical condition to be treated, a mapping basis;
defining a target area for treatment relative to the mapping basis;
identifying a treatment point within the target area; and
injecting a treatment dose of medically approved toxin into the treatment point.

2. The method of claim 1, wherein the step of determining a mapping basis further comprises determining a mapping basis of one or more traditional acupuncture points.

3. The method of claim 1, further comprising the step of anesthetizing the treatment point prior to injecting the treatment dose.

4. The method of claim 1, wherein the step of defining a target area for treatment further comprises defining a plurality of target areas relative to a plurality of mapping bases.

5. The method of claim 1, wherein the step of identifying a treatment point within the target area further comprises identifying a plurality of treatment points within the target area.

6. The method of claim 1, wherein the step of injecting a treatment dose of medically approved toxin further comprises injecting the treatment dose with a 30-gauge, or smaller, needle.

7. The method of claim 1, wherein the step of injecting a treatment dose of medically approved toxin further comprises injecting a treatment dose of less than or equal to 1/50^{th} of 1 unit of medically approved toxin.

8. The method of claim 1, wherein the step of injecting a treatment dose of medically approved toxin further comprises injecting a treatment dose of less than or equal to 1/10^{th} of 1 unit of medically approved toxin.

9. The method of claim 1, wherein the medical condition is Parkinson's disease.

10. The method of claim 1, wherein the medical condition is dementia.

11. A system for localized acupoint microdosing treatment of a medical condition, comprising:
a mapping basis corresponding to a medical condition to be treated;
a target area for treatment defined relative to the mapping basis;
a treatment point identified within the target area; and
a treatment dose of medically approved toxin injected into the treatment point.

12. The system of claim 11, wherein the mapping basis comprises one or more traditional acupuncture points.

13. The system of claim 11, wherein a plurality of treatment points are identified within the target area.

14. The system of claim 11, wherein the treatment dose of medically approved toxin is injected into the treatment point with a 30-gauge, or smaller, needle.

15. The system of claim 11, wherein the treatment dose of medically approved toxin comprises a treatment dose of less than or equal to 1/50^{th} of 1 unit of medically approved toxin.

16. The system of claim 11, wherein the medical condition is Parkinson's disease.

17. The system of claim 11, wherein the medical condition is dementia.

18. A method of localized acupoint microdosing to treat a medical condition, comprising the steps of:
determining, for the medical condition to be treated, a mapping basis comprising one or more traditional acupuncture points;
defining a target area for treatment relative to the mapping basis;
identifying a one or more treatment points within the target area; and
injecting a treatment dose of medically approved toxin into a treatment point.

19. The method of claim 18, wherein the medical condition is Parkinson's disease.

20. The method of claim 18, wherein the medical condition is dementia.

21. The method of claim 18, wherein the medical condition is pain management.

22. The method of claim 18, wherein the medical condition is anxiety.

23. The method of claim 18, wherein the medical condition is depression.
